(19) United States
(12) Patent Application Publication
(10) Pub. No.: US 2011/0282978 A1
(43) Pub. Date: Nov. 17, 2011

(54) BROWSER PLUG-IN

(75) Inventor: Anand Paithankar, Pune (IN)

(73) Assignee: AVAYA INC., Basking Ridge, NJ (US)

(21) Appl. No.: 12/780,567

(22) Filed: May 14, 2010

(51) Int. Cl. G06F 15/173; G06F 15/177; G06F 3/048

(52) U.S. Cl. 709/221; 709/226; 715/843

(57) ABSTRACT

A plug-in runs on a user computer as a part of or in conjunction with a browser and works only on a requested minimum resolvable URL entered by the user before the user types in the complete URL and before the user receives a page load error like “404 page not found.” Once the minimum resolvable URL is entered, a connection is made to the network address. A client component of the browser analyzes the home page of the web site for all the sub-links present on the page. These links are analyzed, validated, resolved, and structured together before presenting to the user. It presents only live links and the site map in a structured format to the user. The user can see the list of available live pages in the browser's address bar drop-down menu with the anchored text.

### FIELD OF THE INVENTION

The invention relates generally to a browser and methods thereof, and more specifically to a browser plug-in, capable of fetching a site map or a web map and presenting the information in a structured format before a user visits the intended network site.

### BACKGROUND OF THE INVENTION

A browser is a software application enabling a user to display and interact with information (text, images, audio and video records and streams, forms, etc.) located on a page (also called a webpage) at a website on a network (such as the World Wide Web or an intranet). Any information on a webpage has an associated attribute allowing the linking of this information to other information at another location on the network.

Different protocols are available to allow communication through a network and handling data in a large number of formats, such as HTML (Hyper Text Markup Language) and application layer protocols, such as layer 7 protocols.

A plug-in (also called a “browser plug-in”) expands the functionalities of a browser by adding extra features to it. Many browser plug-ins are visible to the user and he/she can interact with those plug-ins. A plug-in can be, as an example, a toolbar, a search assistant, or a set of functions allowing blocking of pop-up windows. Other plug-ins are not visible to users and run without Graphical User Interface (GUI) access thereto.

There is a huge growth in the number of network resources being hosted and equal growth in the number of users accessing them. Browsers facilitate network resource access by providing many useful features for navigation across the resource links. The browser experience has not seen many changes and value added features over the same period of time. A user has to type a network resource address or URL [Uniform Resource Locator] to a browser's address bar. The user is directed to a home page, and to navigate to a particular page available on the network site (where network resources are hosted), a user has to go there via the main/home page.

This problem is, to an extent, solved via a “History” maintained by the browsers. Browsers have improved on how they manage “History” (caching already-accessed URLs by the user) so that one can easily get back to a previously-visited URL by just typing a few keywords. However this “History” has limitations; for example, to generate the “History” a user is expected to visit that network resource, and even after creation of the “History” of the visited page, it does not guarantee that it will be valid for future access; in simple terms, the “History” will not necessarily always point to the same resource. In most of the cases the user could see the error message “404 [page not found].”

If the page fetch request does not produce a response from a host at the target address, the browser may display a default message indicating that the requested page cannot be displayed, or may remain idle until the user inputs another URL. In addition, in some cases, the page can be retrieved, but cannot be displayed due to script execution errors, unsupported data formats, or other problems relating to the content of the requested page.

Regardless of the cause, page load errors, and errors involving requests for other types of displayable objects, can be very frustrating to users. The present invention seeks to address this problem.

### SUMMARY OF THE INVENTION

To address the above-discussed deficiencies, an illustrative embodiment of the invention reads a web map/site map and presents all live links to the user in a structured format when the user has entered a minimum resolvable network resource link.

An illustrative embodiment of the present invention provides a method of using a plug-in for providing live web links to the user in a structured format when the user has entered a minimum resolvable network resource link, such as a URL. Once the minimum resolvable network resource link is entered, a connection is made—for example by using Layer 7 Application Layer Protocols—to the network resource link. The browser component analyzes the home page of the site for all the sub-links present on the page. It can also visit the site map present on the site. These links are analyzed, validated, resolved, and structured together before presenting to the user. The user can see the list of available live pages in the browser's address bar drop-down menu, with the anchored text.

In a preferred embodiment, there is provided a plug-in that runs on a user's computer as a part of, or in conjunction with, a browser. The plug-in works only on a requested minimum resolvable URL entered by the user and helps the user to expedite the navigation. The plug-in does not wait for the user to enter a complete URL and for the system to give a “404 [page not found]” error. Instead, it presents only live network resource links and a site map in a structured format to the user before an error is generated or the user types in the complete URL.

An aspect of the present invention is that it operates generally in an independent manner. The plug-in does not require any web page storage server to store the web pages indexed or a database to store the cached web page links. The plug-in does not look into the “History” cache but it directly reads the site map and recursive links to present to the user.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above.

### BRIEF DESCRIPTION OF THE DRAWINGS

The present invention is described in accordance with the appended figures.

FIG. 1 shows a sequence of interactions that may occur between a web browser on a user computing device and an error processing server to handle a page load error.

FIGS. 2 and 3 show a flowchart illustrating an exemplary method of using a browser plug-in to read a web map/site map or a list of URLs and present all live links or URLs to the user in a structured format when the user has entered a minimum resolvable URL.

FIG. 4 shows an example of a type of page that may be displayed using the present invention.

In the appended Figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

As used throughout this patent document, the terms “include” and “comprise,” as well as derivatives thereof, mean inclusion without limitation; the term “or” is inclusive, meaning and/or; the phrases “associated with” and “associated therewith,” as well as derivatives thereof, can include, be included within, interconnect with, contain, be contained within, connect to or with, couple to or with, be communicable with, cooperate with, interleave, juxtapose, be proximate to, be bound to or with, have, have a property of, or the like. The term “network resource/s” used in the entire document can include web site(s), web site links, network site(s), file browser links, and the like. The term “page” used in the entire document can mean to include web page, network resource page, and the like. Further the term “browser” used in the entire document means to include a user interface on a computing device that allows navigation of objects such as a web browser, a file browser, and the like. Definitions for certain words and phrases are provided throughout this document. Those of ordinary skill in the art should understand that in many, if not most, instances such definitions apply to prior as well as future uses of such defined words and phrases.

For purposes of illustration, the invention will be described primarily in the context of web pages requested by typing a minimum resolvable URL. As will be recognized, the invention may also be applied to the retrieval of other types of objects and resources, such as PDF (Portable Document Format) documents and image files and may be used in conjunction with a user interface on a computing device that allows navigation of objects such as a file browser.

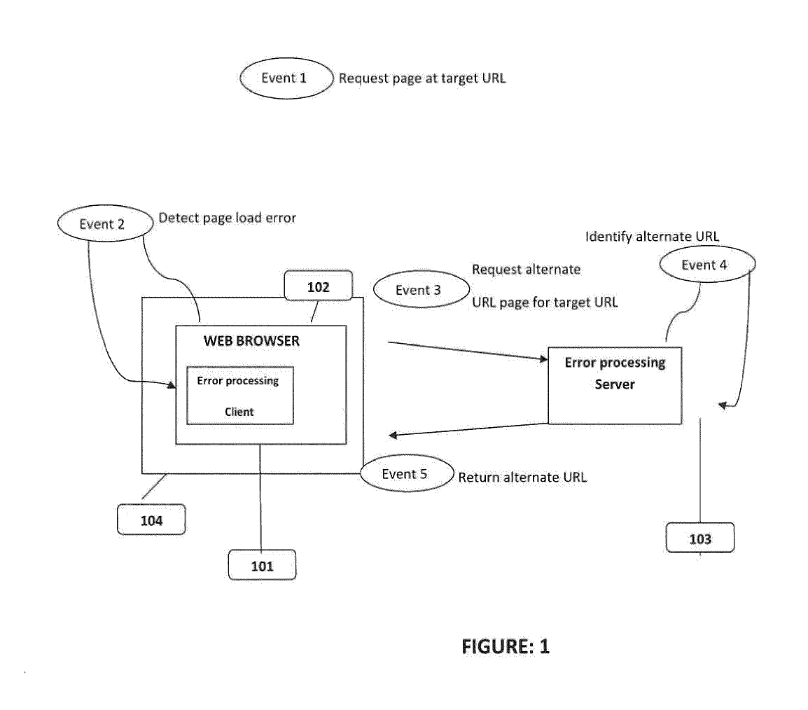

FIG. 1 illustrates a typical sequence of interactions that may occur when a page request results in a page load error. The page request (event 1) may be a request for a web page at any target URL. An error processing client 101 may detect the error (event 2) by monitoring the content of responses from a server 103 received by a web browser 102 (e.g., to look for predefined strings such as “404,” “error,” “page not found,” and “unable to display” in the returned web pages) on a user computing device 104. The error processing client 101 may also treat a web server's failure to respond within a fixed or user-configurable timeout period as a page load error. Further, the error processing client 101 may monitor error messages generated by the web browser 102 to detect page load errors on a user computing device 104.

Upon detecting a page load error, the error processing client 101 causes the web browser 102 to send a request to the error processing server 103 for an alternate object for the target URL (event 3). In response to the request, the error processing server 103 selects an alternate object to present to the user (event 4), and in some embodiments, generates the selected alternate object.

The error processing server 103 then returns the alternate object, or the URL of the alternate object, to the web browser 102 (event 5) on a user computing device 104. The web browser 102 on a user computing device 104 may display the alternate object in a main browsing window, or in a window or other area that is separate from the main window (e.g., a separate pop-up window).

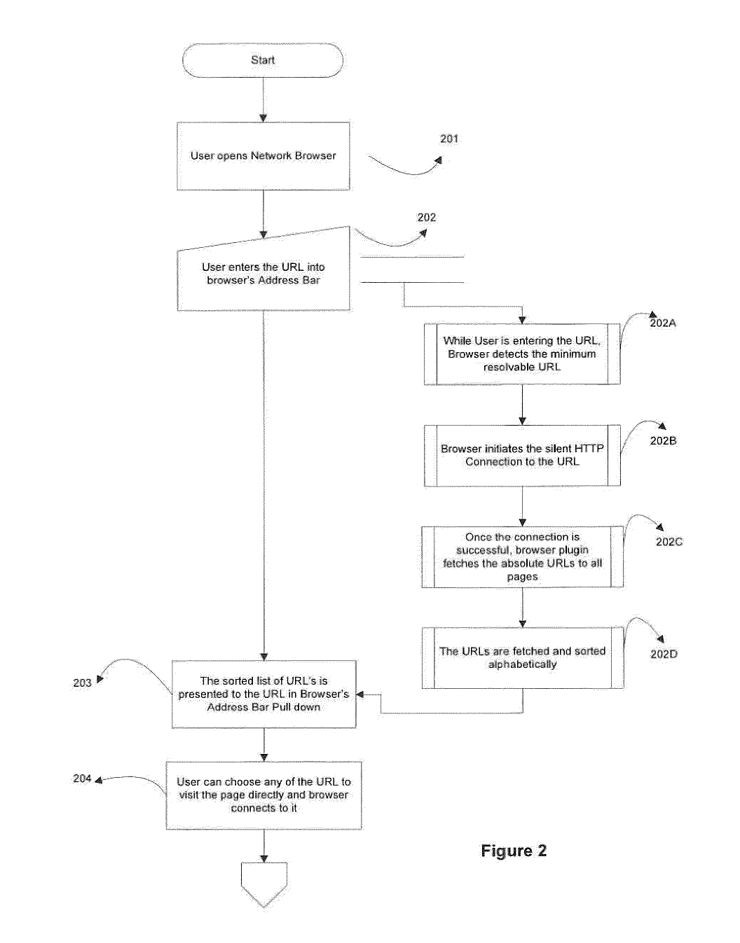

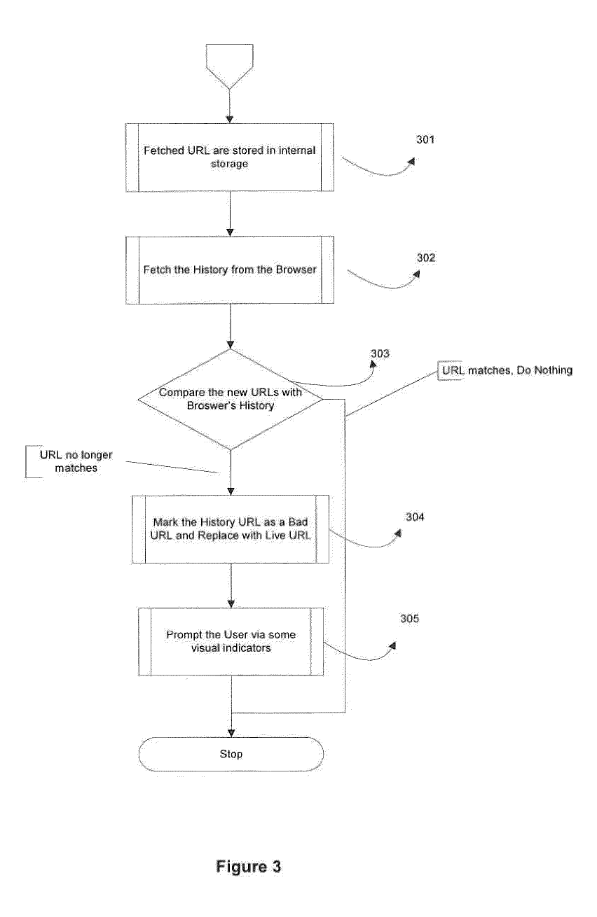

FIGS. 2 and 3 illustrate one example of a method that may be used by web browser 102 to read a web map/site map or a list of URLs and present all live URLs to the user in a structured format when the user has entered a minimum resolvable URL at a user computing device that runs web browser 102. At step 201, a user opens the web browser 102. After opening the web browser 102, the user enters the URL into the web browser's address bar at step 202. While the user is entering the URL into the web browser's address bar, a plug-in that runs on a user's computer as a part of or in conjunction with a web browser detects a minimum resolvable URL at step 202A. Once the minimum resolvable URL has been detected, the plug-in initiates an HTTP connection to the website addressed by the minimum resolvable URL entered by the user into web browser 102, at step 202B. Once the connection is successfully established with the intended URL entered by the user, the plug-in fetches all URLs to all pages of the URL entered by the user, at step 202C. After fetching, all the URLs to all pages are sorted out alphabetically at step 202D.

Once the fetched URLs of the intended website are sorted and arranged alphabetically, the list of said URLs is presented to the user in the browser's address bar in the form of a pull down menu, at step 203. Once the list of URLs is presented to the user in a structured format, like an aphetically arranged pull down menu, the user can directly choose any of the URLs from the pull down menu of all URLs to all pages of the website at step 204 to get the active page or pages of the website. These fetched URLs of the website are also stored in an internal storage, such as a local hard drive of the user's computer, at step 301 for further processing, such as comparing with the “History” available in the browser, correcting the URLs available in the “History,” and the like.

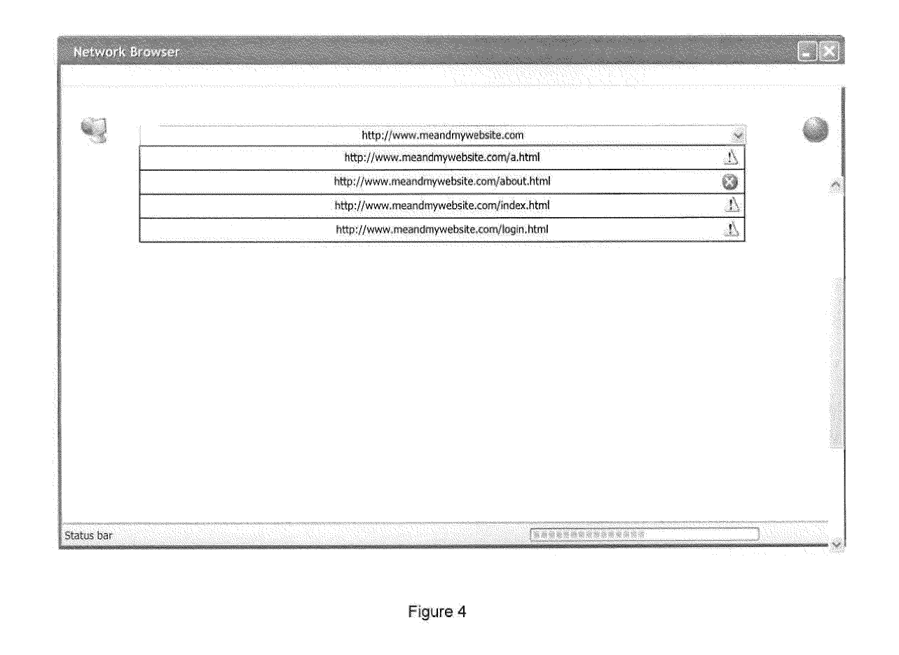

After storing the fetched URLs, the plug-in fetches the “History” from the web browser 102 that is already cached in the browser at step 302. After fetching the cached “History” from the web browser relevant to the URL entered by the user, the plug-in compares the new URLs with the relevant URL cached “History” from the browser, at step 303. If the new URLs match the URL from the cached “History” from the web browser the process ends. But if the list of new URLs or the new URL is different from the cached browser “History,” which is old and gives an error such as “404,” “error,” “page not found,” and “unable to display” in the returned web pages and the like, then that URL is marked as a bad URL and replaced by the new URLs, or the new URL, at step 304. Once the old URL from the cached browser “History” is replaced by the new URLs or the new URL, the plug-in notifies the user via a visual indicator about the replacement of the old cached “History” URL with the new, correct and live URLs or new URL at step 305. An example of such a corrected “History” is shown in FIG. 4.

The foregoing description of the Web browser plug-in has been presented for the purposes of illustration and description. It is not intended to be exhaustive or to limit the claimed subject matter to the precise form disclosed. The user computing device mentioned in the above paragraphs may be one of a network-enabled PDA (Personal Digital Assistant), smart phone, feature phone, smart book, tablet personal computer, or portable media player. And the said network is an internet, intranet, private or public close group peer-to-peer or broadcast network or data network. Furthermore, a “minimum resolvable URL address” is an address that enables a network application layer protocol to connect to the target URL successfully. Many modifications and variations are possible in light of the above teaching. For example, the present invention works independently of the cached “History” of the target URL in the browser. The present invention does not require any “History” of the target URL to initiate the process of obtaining live and active network resource links of the target URL. It is intended that the scope of the invention be limited not by this detailed description, but rather by the claims appended hereto.

We claim:

1. A method of providing live network resource links to a user, the method comprising:
in response to the user entering a minimum resolvable network resource link into a browser on a user computing device, determining from the entered network resource link a target network resource link;
initiating a connection to the target network resource link;
determining whether the connection is successful or not;
if the connection is successful then fetching an absolute at least one network resource link to all sub-resources of the target network resource link;
presenting the absolute at least one network resource link in the browser to the user to enable the user to select a correct and live network resource link.

2. The method as claimed in claim 1 wherein: presenting the absolute at least one network resource link to the user comprises displaying the at least one absolute network resource link in an address bar of the browser in a form of a pull-down menu.

3. The method as claimed in claim 2, wherein: said absolute at least one URL is stored locally on a hard drive of the computing device of the user.

4. The method of claim 1 wherein: each network resource link comprises a URL (Uniform Resource Locator).

5. The method as claimed in claim 4 wherein: the browser initiates the connection to the target URL using one or more network application layer protocols.

6. The method as claimed in claim 4 wherein: the minimum resolvable URL comprises a network address that enables a network application layer protocol to connect to the target URL successfully.

7. The method as claimed in claim 5 wherein: the network application protocol comprises one or more Layer 7 protocols.

8. The method as claimed in claim 1 wherein the user computing device comprises a network-enabled device for a network.

9. The method as claimed in claim 7 wherein the network comprises at least one of an internet, an intranet, a private or public close group, peer-to-peer or broadcast network, and a data network.

10. The method as claimed in claim 7 wherein: the network-enabled device comprises at least one of a PDA (Personal Digital Assistant), a smart phone, a feature phone, a smart book, a tablet, personal computer, or a portable media player.

11. The method as claimed in claim 1 wherein network resource links comprise at least one of web site links, network site links, and file browser links.

12. The method as claimed in claim 4 further comprising:
fetching the browser's “History” which is already cached in the browser and comprising at least one URL that is relevant to the minimum resolvable URL entered by the user;
comparing the absolute at least one URL with a relevant at least one URL cached in the “History”;
determining whether the absolute at least one URL is different from the cached relevant at least one URL;
in response to determining that the absolute at least one URL is different from the cached relevant at least one URL, marking the cached at least one URL as a bad URL and replacing the bad URL by the absolute at least one URL; and
notifying the user of the replacement of the bad URL with the absolute at least one URL.

13. The method as claimed in claim 10 wherein: the bad URL is a URL which gives an error such as “404,” “error,” “page not found,” and “unable to display” in a returned error message.

14. The method as claimed in claim 10 wherein the user is notified of the replacement via at least one of a visual indicator and an audio announcement.

15. The method as claimed in any one of claims 1-14 wherein the browser comprises a network browser.

16. The method as claimed in claim 15 wherein the network browser comprises at least one of a web browser and a file browser.

17. A computer readable medium comprising processor-executable instructions which, when executed by a processor, cause the processor to perform the method of one of claims 1-14.

18. An apparatus comprising:
a browser;
a computing device operable by a user, responsive to the user entering a minimum resolvable network resource link into a browser by determining from the entered resource link a target resource link, initiating a connection to the target resource link, determining whether the connection is successful or not, and if the connection is successful then fetching an absolute at least one resource link to all sub-resources of the target resource link and presenting the absolute at least one resource link to the user to enable the user to select a correct and live resource link.

19. The apparatus of claim 18 wherein each resource link comprises a URL (Uniform Resource Locator).
